(19) United States
(12) Patent Application Publication
(10) Pub. No.: US 2009/0127999 A1
(43) Pub. Date: May 21, 2009

(54) Discharge lamp with a monolithic ceramic color converter

(75) Inventors: Jorg Meyer, Aachen (DE); Peter J. Schmidt, Aachen (DE); Rainer Hilbig, Aachen (DE); Herbert Schreinemacher, Baesweiler (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 11/914,082

(22) PCT Filed: May 3, 2006
(86) PCT No.: PCT/IB06/51391

§ 371 Date: Jun. 19, 2008

(30) Foreign Application Priority Data
May 11, 2005 (EP) 05103953.5

(51) Int. Cl. H01J 61/44; C09K 11/78

(52) U.S. Cl. 313/486; 264/21

(57) ABSTRACT

The invention relates to a light emitting device, in particular discharge lamps with inner or outer electrodes or electrodeless in which the emittance of red light is enhanced by using a monolithic ceramic luminescence converter.

### FIELD OF THE INVENTION

This invention relates to the field of light emitting devices, in particular discharge lamps with inner or outer electrodes or electrodeless.

### BACKGROUND OF THE INVENTION

Discharge lamps usually comprise a gas discharge and one or several color converters, which convert a part of the light and/or radiation emitted by the gas. In certain cases these color converters are doped with trivalent rare earth metals, since these are known to be efficient line emitters. However excitation via intrinsic f-f-transitions with rather weak absorption coefficients leads to low light outputs (i.e. quantum yield multiplied by the absorption), therefore excitation of these color converters usually has to occur via the band gap of the host lattice or charge transfer states. As a consequence the emission of the discharge has to be in the UV-B/UV-C region of the electromagnetic spectrum in order to achieve the required minimum of conversion, which also means that large stokes shifts will infer high quantum losses into the final discharge lamps limiting overall efficiency.

### SUMMARY OF THE INVENTION

It is therefore an object of the present invention to provide a discharge lamp, which comprises a color converter, which is able to convert incoming light with a higher efficacy.

Accordingly, a light emitting device, in particular a discharge lamp with inner or outer electrodes or electrodeless is provided comprising at least one monolithic ceramic luminescence converter which is essentially made out of the doped material M^{I}₂O₃:MII, whereby M^{I} is selected out of the group comprising Y, La, Gd, Lu and Sc or mixtures thereof, M^{II} is selected out of the group comprising Ce, Pr, Nd, Pm, Sm, Eu, Gd, Th, Dy, Ho, Er, Tm, Yb, Lu, Bi, Sb or mixtures thereof and the doping level is ≧0.01 and ≦15%.

By choosing a monolithic ceramic luminescence converter as defined with the present invention, the absorption of the incident light by color converter can be greatly enhanced.

In contrast to the common powder phosphors in which the optical path length of the incident light is limited to some μm at most due to scattering, this path length may be increased by several orders of magnitude by a monolithic ceramic luminescence converter according to the present invention. As the absorption is a product of optical path length and absorption coefficient of the absorbing species, it is enhanced for a given absorber (at a given concentration) scaling with the distance photons travel through the absorbing material.

A monolithic ceramic luminescence converter in the sense of the present invention is in particular a material, which employs one or more of the following features: macroscopic lateral dimensions (i.e. ≧50 μm and ≦100 mm length of the shortest lateral dimension of the ceramic body, low surface area, ≦1 m²/g and ≧10⁻⁷ m²/g, a density of ≧95% and ≦100% of the theoretical density, macroscopically homogeneous, ≧0% and ≦10% contaminants (content in molar ratio of elements not belonging to the nominal composition), phase pure, ≧90% and ≦100% phase purity, translucent or transparent.

M^{I} is selected out of the group comprising Y, La, Gd, Lu and Sc or mixtures thereof. The oxides of these elements have shown to be the best suitable carrier materials for use within the present invention.

M^{II} is selected out of the group comprising Ce, Pr, Nd, Pm, Sm, Eu, Gd, Th, Dy, Ho, Er, Tm, Yb, Lu, Bi, Sb or mixtures thereof. These materials have shown to be suitable for the present invention due to their ability to emit light via intrinsic f-f-transitions, or sensitize this type of emission.

The doping level, which is the molar amount of activator (M^{II}) in the host lattice relative to M^{I}, is ≧0.01 and ≦15%. Preferably, the doping level is ≧0.1 and ≦12%, more preferred ≧1 and ≦10%, yet more preferred ≧2 and ≦9%. and most preferred ≧3 and ≦8%

In the sense of the present invention, the term “essentially made of” means a wt-% content of ≧90, preferably ≧95, more preferred ≧98, most preferred ≧99 and ≦100.

According to a preferred embodiment of the present invention, the at least one monolithic ceramic luminescence converter is translucent and/or transparent.

Translucent in the sense of the present invention means in particular that ≧50% preferably ≧60%, more preferred ≧70%, most preferred ≧90% and ≦100% of the incident light of a wavelength, which cannot be absorbed by the material, is transmitted through the sample (at an arbitrary angle). This wavelength is preferably in an area of ≧400 nm and ≦1000 nm, preferably ≧450 nm and ≦900 nm, and most preferred ≧500 nm and ≦700 nm.

Transparent in the sense of the present invention means in particular that an incident light beam leaves a transparent object with parallel faces under the same angle ≦±5° under which it enters it, i.e. a very low amount of scattering centres is present in the sample.

By applying transparent monolithic ceramic color converters it is possible to increase the optical path length in such a fashion that even weakly absorbing transitions may be used for excitation of the luminescent centres. A typical phosphor layer for luminescent lighting consisting of particles with an average particle size of 5 μm will have a thickness of about 20 μm, this results in an optical path length of ca. 40 μm, a 1 mm thick transparent or translucent ceramic will enhance this value by a factor of at least 25. An additional advantage in the case of emissions of the discharge in the visible is that the transmittance of non-absorbed light is increased from ca. 30% for the powder layer to ≧50% for the translucent or transparent ceramic.

According to a preferred embodiment of the present invention, the shortest lateral dimension of the at least one monolithic ceramic luminescence converter is ≧50 μm and ≦100 mm. Preferably, the shortest lateral dimension of the at least one monolithic ceramic luminescence converter is ≧100 μm and ≦10 mm, more preferred ≧150 and ≦5 mm, yet more preferred ≧200 μm and ≦2 mm. and most preferred ≧250 μm and ≦1 mm.

By choosing such a shortest lateral dimension for the monolithic ceramic luminescence converter it is ensured that the pathway of the light inside the luminescence converter is long enough, resulting in adequate absorption efficiency.

According to a preferred embodiment of the present invention, the product of thickness (in mm) and doping level (in %) of the monolithic ceramic luminescence converter is ≧0.02 mm and ≦0.5 mm. Preferably, the product of the thickness and doping level of the at least one monolithic ceramic luminescence converter is ≧0.04 mm and ≦0.4 mm, more preferred ≧0.05 mm and ≦0.3 mm, yet more preferred ≧0.075 mm and ≦0.25 mm. and most preferred ≧20.1 mm and ≦0.2 mm.

By adjusting thickness and doping level simultaneously it becomes possible to obtain materials with highly reproducible absorption properties. Fine-tuning of the thickness of the samples (e.g. by abrasion) will allow influencing absorption (and thus also light output) to a much higher degree than possible with powder phosphors.

According to a preferred embodiment of the present invention, the at least one monolithic ceramic luminescence converter has a density of ≧95% and ≦100% of the theoretical density.

According to a preferred embodiment of the present invention, the at least one monolithic ceramic luminescence converter has ≧90% and ≦100% phase purity.

According to a preferred embodiment of the present invention, the surface roughness RMS (disruption of the planarity of a surface; measured as the geometric mean of the difference between highest and deepest surface features) of the entrance surface for the incoming light of the monolithic ceramic luminescence converter is ≧0.001 μm and ≦100 μm. Preferably, the surface roughness of the entrance surface of at least one monolithic ceramic luminescence converter is ≧0.01 μm and ≦10 μm, more preferred ≧0.1 μm and ≦5 μm, yet more preferred ≧0.15 μm and ≦3 μm. and most preferred ≧0.2 μm and ≦2 μm. By doing so, it is ensured that the incoming light will properly enter the luminescence converter, which results in a yet higher emittance rate.

According to a preferred embodiment of the present invention, the outer surface of the at least one monolithic ceramic luminescence converter has is structured or covered with an outcoupling layer, that is formed preferably by a powder layer. Most preferred is a outcoupling phosphor powder layer that further converts light not converted by the monolithic ceramic luminescence converter into visible light. Preferably, this phosphor powder is made essentially out of a material selected out of the group barium magnesium aluminate doped with europium, BaMgAl₁₀O₁₇:Eu, barium strontium oxonitridoalumosilicate doped with europium, (Ba,Sr)Si₆₋ₓAlₓN₈₋ₓO_{x+y}:Eu (0≦y≦1), yttrium gadolinium aluminum garnet doped with cerium, (Y,Gd)₃Al₅O₁₂:Ce, barium strontium orthosilicate doped with europium, (Ba,Sr)₂SiO₄:Eu, strontium barium oxonitridosilicate doped with europium, (Sr,Ba)Si₂N₂O₂:Eu or mixtures thereof.

According to a preferred embodiment of the present invention, the specific surface area of the monolithic ceramic luminescence converter is ≧10⁻⁷ m²/g and ≦1 m²/g. The reduced specific surface area increases the stability of the monolithic ceramic luminescence converter towards chemical and physical attack. Inertness of these structures against e.g. the discharge or hard UV radiation is a function of surface area and proportional to this material characteristic.

According to a preferred embodiment of the present invention, the light emitting device comprises a discharge gas, which emits light with a mean wavelength ≧120 nm and ≦1000 nm.

In the sense of the present invention, the term “mean wavelength” is in particular defined as follows:

From a measured emission spectrum the spectral power per wavelength is determined from the number of photons Nₚₕₒₜ [h: Planck constant, c: velocity of light]

$$P ( λ ) = {N}_{phot} ( λ ) \cdot h \cdot \frac{c}{λ}$$

The total optical power Pₜₒₜ that is emitted is given by integrating P(λ) over the wavelength range. This power can also be used to define the mean emission wavelength λₘₑₐₙ:

$${P}_{tot} = \int P ( λ ) d λ = h \cdot \frac{c}{{λ}_{mean}} \cdot \int {N}_{phot} ( λ ) d λ$$

Preferably, the discharge emits light with a mean wavelength ≧200 nm and ≦900 nm, more preferred ≧250 nm and ≦800 nm, yet more preferred ≧275 nm and ≦750 nm. and most preferred ≧280 nm and ≦700 nm. By doing so, radiation damage to lamp components can be minimized and furthermore the quantum losses for the phosphor conversion are reduced resulting in much higher luminous efficacies of the lamp.

According to a preferred embodiment of the present invention, the light emitting device comprises a reflector, which is made of an material reflective for light with a wavelength of ≧120 nm and ≦110 μm. This allows to build the light emitting device with the at least one monolithic ceramic luminescence converter in form of an aperture, as will be described below.

A light emitting device according to the present invention may be employed with inner or outer electrodes or be electrodeless. For some applications, however, the operation of the lamps without inner lamp electrodes (i.e. electrodeless) is advantageous due to the fact that there exists no screening for the radiation by the inner lamp electrodes.

A light emitting device according to the present invention may provide white or colored light in operation. Some of the light emitted by the discharge excites the monolithic ceramic luminescence converter, causing it to emit light in a different wavelength. However, there is also the possibility that the UV to blue light emitted by the discharge is transmitted through the color converter and is mixed with light emitted by it. The viewer perceives the mixture of this light as white or colored light. It is therefore possible to form polychromatic white light, depending on the amount and ratio of colors, e.g. by additive color triads, for example blue, green and red. The formation of colored light sources is likewise possible by the suitable choice of the number and amount of color converters.

A light emitting device according to the present invention may be of use in a broad variety of systems and/or applications, amongst them one or more of the following: Office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, and decorative lighting systems, portable systems, automotive applications, green house lighting systems.

The present invention also relates to a method of preparing a monolithic ceramic luminescence converter as described above comprising the following steps: Admixing a salt of M^{I}, preferably selected from the group comprising halogenides, sulfates, nitrates, perchlorates or mixtures thereof in deionised water, addition of a salt of M^{II}, preferably selected from the group comprising halogenides, sulfates, nitrates, perchlorates or mixtures thereof, optionally addition of a carbonate or hydroxide source selected from the group comprising urea, oxalic acid, ammonium carbonate and mixtures thereof, stirring, until an homogenous mixture has been obtained, optionally under heating, obtaining of a precipitate, which is dried, calcination of the precipitate, optionally mixing of the precursor with a binder, ringing the precursor materials in the desired shape, preferably by slip casting and/or injection moulding, formation of the monolithic ceramic luminescence converter by ceramic techniques, e.g. by vacuum sintering, hot isostatic pressing or hot uniaxial pressing.

This method was proven to be a suitable way of obtaining a monolithic ceramic luminescence converter as required for a light-emitting device according to the present invention.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the subclaims, the figures and the following description of the respective figures and examples, which—in an exemplary fashion—show several preferred embodiments of a light emitting device according to the invention.

### BRIEF DESCRIPTION OF THE DRAWINGS

FIG. 1 shows a schematic cross-sectional view of a light emitting device according to a first embodiment of the present invention;

FIG. 2 shows a schematic cross-sectional view of a light emitting device according to a second embodiment of the present invention;

FIG. 3 shows a diagram of an excitation spectrum of a monolithic ceramic luminescence converter as employed within the present invention together with an excitation spectrum of a luminescence converter according to a comparative example; and

FIG. 4 shows a diagram of a reflection spectrum of a monolithic ceramic luminescence converter as employed within the present invention together with a reflection spectrum of a luminescence converter according to a comparative example.

### DETAILED DESCRIPTION

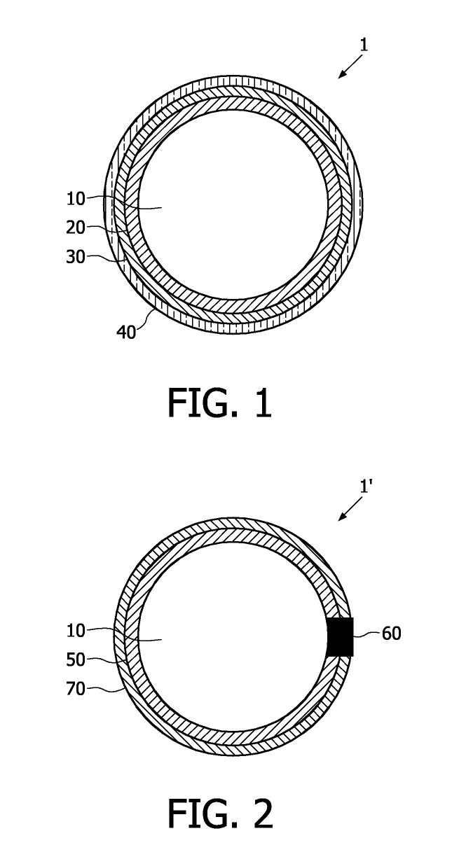

FIG. 1 shows a schematic cross-sectional view of a light emitting device according to a first embodiment of the present invention. The light emitting device 1 is a gas discharge lamp, with inner electrodes or outer electrodes or electrodeless and comprises a gas 10 inside a first inner envelope 20. This envelope is made out of glass which comprises an inner wall phosphor powder coating containing the discharge. The first inner envelope 20 is surrounded by a first monolithic ceramic conversion layer 30 (e.g. Y₂O₃:Er (8%), thickness 3 mm) according to the present invention, which itself is surrounded by a second monolithic ceramic conversion layer 40 (e.g. Y₂O₃:Eu (8%), thickness 1 mm) according to the present invention.

It should be noted that since the layers 30 and 40 are translucent, it is also possible to have the envelope 20 located around the layer 40 or in between the both. The order of the layers 20, 30 and 40 is variable, which is a further advantage of the present invention.

FIG. 2 shows a schematic cross-sectional view of a light-emitting device according to a second embodiment of the present invention. This light-emitting device 1′ is a gas discharge lamp, with inner electrodes or outer electrodes or electrodeless, too. The difference between the first and second embodiment is that in this embodiment a reflective layer 50 is used, which is either coated on the inner side with or consists out of a reflective material, which reflects at least the light emitted by the discharge, i.e. UV-A light. The reflective layer is usually surrounded by a further layer 70, which can be variable. In most applications, the layer 70 will simply be made of glass.

The monolithic ceramic luminescence converter according to the present invention is formed to fit inside the aperture 60. Light that is emitted by the discharge can only leave the lamp via this aperture due to the reflective layer 50. An arrangement like this is in principle known in the prior art, e.g. in the EP 04104722.6 which is incorporated here by reference. An arrangement like in the second embodiment of the present invention bears the advantage that the exit area of the light can be controlled; furthermore the monolithic ceramic luminescence converter can be made more simple, compact and smaller than in the above arrangement, which, however, might as well be advantageous for some applications.

A monolithic ceramic luminescence converter and a method of making the same according to the invention is—in a merely exemplarily fashion—furthermore illustrated by the following example:

### EXAMPLE I

In a 40 L glass lined vessel 1.35 L of a 0.5 M YCl3 solution (in deionised water), 33.46 g Eu(NO3)3*6H2O and 1.4625 kg urea are dissolved in water while stirring vigorously. Further water is added to a final volume of 30 L. The solution is heated to boiling (100° C.) and after the first turbidity has occurred, it is heated for an additional period of 2 h. The precipitate is collected on a Büchner funnel and washed to remove chloride. It is then dried and subsequently calcined at 800° C. for 2 h.

The resulting precursor powder consists of spherical particles with an average size of 250 nm. It is processed to green bodies by known ceramic techniques: The powder is ground in an agate mortar with 10% w/w of binder (5% polyvinylalcohol in water). It is passed through a 500 μm sieve and pressed to green bodies by use of a powder compacting tool and subsequent cold isostatic pressing at 3200 bar. The green bodies are sintered to transparent monolithic ceramics in vacuum at 1700° C.

### COMPARATIVE EXAMPLE I

In a 40 L glass lined vessel 1.35 L of a 0.5 M YCl3 solution (in deionised water), 33.46 g Eu(NO3)3*6H2O and 1.4625 kg urea are dissolved in water while stirring vigorously. Further water is added to a final volume of 30 L. The solution is heated to boiling (100° C.) and after the first turbidity has occurred, it is heated for an additional period of 2 h. The precipitate is collected on a Büchner funnel and washed to remove chloride. It is then dried and subsequently calcined at 800° C. for 2 h.

The resulting precursor powder consists of spherical particles with an average size of 250 nm.

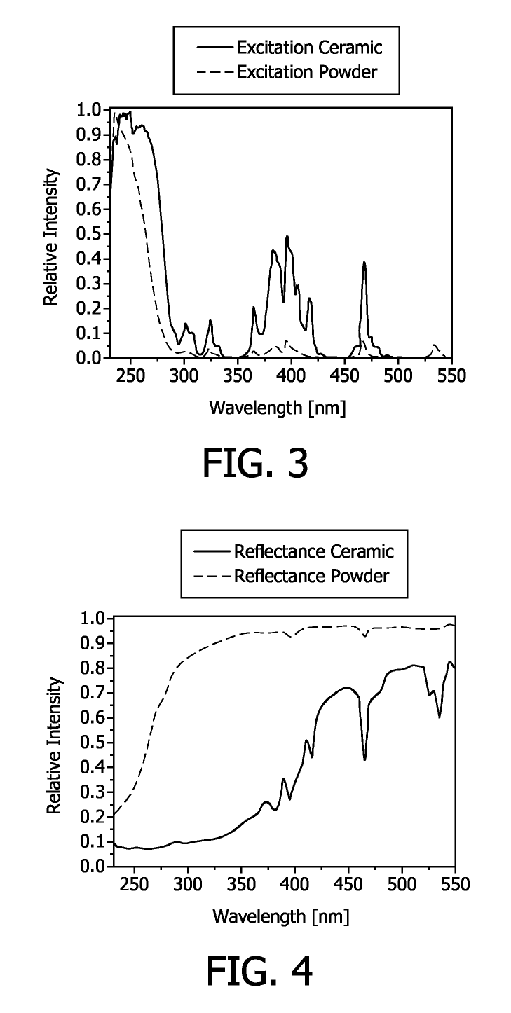

FIG. 3 shows a diagram of an excitation spectrum of the structure of Example I (indicated as “Excitation Ceramic”) within the present invention together with an excitation spectrum of a luminescence converter according to the comparative example I (indicated as “Excitation Powder”). FIG. 4 shows a diagram of a reflection spectrum of the structure of Example I (indicated as “Excitation Ceramic”) within the present invention together with a reflection spectrum of a luminescence converter according to the comparative example I (indicated as “Excitation Powder”).

It can be seen that the excitability and absorption of the ceramic in the UVA and blue spectral region are greatly enhanced compared to the conventional powder phosphor.

1. Light emitting device, in particular a discharge lamp with inner or outer electrodes or electrodeless comprising at least one monolithic ceramic luminescence converter which is essentially made out of the doped material M^{I}₂O₃:M^{II}, whereby M^{I} is selected out of the group comprising Y, La, Gd, Lu and Sc or mixtures thereof, M^{II} is selected out of the group comprising Ce, Pr, Nd, Pm, Sm, Eu, Gd, Tb, Dy, Ho, Er, Tm, Yb, Lu, Bi, Sb or mixtures thereof, and the doping level is ≧0.01 and ≦15%.

2. Light emitting device according to claim 1, whereby the at least one monolithic ceramic luminescence converter is translucent and/or transparent.

3. Light emitting device according to claim 1, whereby the shortest lateral dimension of the at least one monolithic ceramic luminescence converter is ≧50 μm and ≦100 mm.

4. Light emitting device according to claim 1, whereby the product of thickness and doping level of the monolithic ceramic luminescence converter is ≧0.02 mm and ≦0.5 mm.

5. Light emitting device according to claim 1, whereby the surface roughness of the excitation light entrance surface of the monolithic ceramic luminescence converter is ≧0.001 μm and ≦100 μm.

6. Light emitting device according to claim 1, whereby the specific surface area of the monolithic ceramic luminescence converter is ≧10⁻⁷ m²/g and ≦1 m²/g.

7. A light emitting device according to claim 1, furthermore comprising a discharge gas, which emits light with a mean wavelength ≧120 nm and ≦1000 nm.

8. A light emitting device according to claim 1, furthermore comprising an reflector, which is made of an material reflective for light with a wavelength of ≧2120 nm and ≦110 μm.

9. Method of preparing a monolithic ceramic luminescence converter of a light emitting device according to claim 1 comprising the following steps:
Admixing a salt of M^{I}, preferably selected from the group comprising halogenides, sulfates, nitrates and perchlorates or mixtures thereof in deionised water, addition of a salt of M^{II}, preferably selected from the group comprising halogenides, sulfates, nitrates and perchlorates or mixtures thereof, optionally addition of a carbonate or hydroxide source selected from the group comprising urea, oxalic acid, ammonium carbonate and mixtures thereof, stirring, until an homogenous mixture has been obtained, optionally under heating, obtaining of a precipitate, which is dried, calcination of the precipitate, optionally mixing of the precursor with a binder, bringing the precursor materials in the desired shape, preferably by slip casting and/or injection moulding, formation of the monolithic ceramic luminescence converter by ceramic techniques, e.g. by vacuum sintering, hot isostatic pressing or hot uniaxial pressing.
